(19) United States
(12) Patent Application Publication
(10) Pub. No.: US 2016/0065881 A1
(43) Pub. Date: Mar. 3, 2016

(54) DISPLAY APPARATUS AND METHOD OF CONTROLLING THE SAME

(71) Applicant: SAMSUNG ELECTRONICS CO., LTD., Suwon-si (KR)

(72) Inventor: Sung Ju KIM, Uiseong-gun (KR)

(73) Assignee: SAMSUNG ELECTRONICS CO., LTD., Suwon-si (KR)

(21) Appl. No.: 14/748,411

(22) Filed: Jun. 24, 2015

(30) Foreign Application Priority Data
Sep. 3, 2014 (KR) 10-2014-0117166

(51) Int. Cl. H04N 5/45; H04N 21/426; H04N 9/64; H04N 5/50; H04N 5/445; H04N 5/44

(52) U.S. Cl. CPC H04N 5/45; H04N 5/44591; H04N 5/4448; H04N 9/641; H04N 5/50; H04N 21/4263; H04N 2005/44595; H04N 2005/4412; H04N 2005/4407

(57) ABSTRACT

Disclosed herein are a display apparatus including a tuner including one tuner, a display configured to display a plurality of images in a plurality of divided regions, and a controller configured to control the tuner to sequentially lock a plurality of channels and control the display to display an image of a currently locked channel as a moving image and an image of a previously locked channel as a still image.

### CROSS-REFERENCE TO RELATED APPLICATION

This application claims priority from Korean Patent Application No. 10-2014-0117166, filed on Sep. 3, 2014 in the Korean Intellectual Property Office, the disclosure of which is incorporated herein by reference in its entirety.

### BACKGROUND

1. Field

Methods and apparatuses consistent with exemplary embodiments relate to display apparatuses receiving broadcast signals and methods of controlling the same.

2. Description of Related Art

Display apparatuses are devices capable of displaying visible images and three-dimensional images.

In recent years, a variety of flat display devices have been developed with fewer restrictions on installation space due to reduced weight and volume as compared to cathode ray tube (CRT) displays. These flat display devices have excellent characteristics, such as a large image display area, high degree of flatness, and high image quality.

Exemplary flat display devices include liquid crystal displays (LCDs), electro-luminescence displays (ELDs), field emission displays (FEDs), plasma display panels (PDPs), thin film transistor liquid crystal displays (TFT-LCDs), and flexible displays.

As LCDs are light and thin, and consume relatively low power, they have been widely used as thin TVs, monitors, portable displays, and applications thereof continue to grow.

A display apparatus may receive broadcast signals transmitted by broadcasting stations and display an image thereof on a display.

The display apparatus may separately receive analog and digital broadcast signals by selecting a channel by using one tuner or simultaneously receive analog and digital broadcast signals by using a plurality of tuners. The display apparatus may display an image thereof on the display.

The display apparatus may automatically perform a channel scan to determine a channel map of all channels.

Thus, a user may select one of one or more channels stored in the channel map by operating a remote control or a channel button of the display apparatus.

Because the display apparatus provides channel information of one channel at a time in response to one manipulation signal of the channel button, the user must continuously manipulate the channel button in order to identify programs of multiple channels stored in the channel map.

### SUMMARY

Aspects of the exemplary embodiments provide display apparatuses displaying images of a plurality of channels by using one tuner when a channel change command is input and methods of controlling the same.

Aspects of the exemplary embodiments also provide display apparatuses displaying an image of a locked channel among images of a plurality of channels displayed on the display as a moving image and displaying images of the other channels as still images and methods of controlling the same.

Additional aspects of exemplary embodiments will be set forth in part in the description which follows and, in part, will be obvious from the description, or may be learned by practice of the disclosure.

According to an aspect of the an exemplary embodiment, there is provided a display apparatus including a tuner, a display configured to display a plurality of images in a plurality of divided regions, and a controller configured to control the tuner to sequentially lock a plurality of channels and control the display to display an image of a currently locked channel as a moving image and an image of a previously locked channel as a still image.

The controller may control the tuner to update the currently locked channel to correspond to another channel of the plurality of channels after a predetermined time period has lapsed.

The display apparatus may further include a storage configured to store an image of the previously locked channel, and the controller may control the storage to store the image of the previously locked channel and control the display to simultaneously display the image of the previously locked channel and the image of the currently locked channel.

The display apparatus may further include a receiver configured to receive a channel signal of a channel button and a confirmation signal of a confirmation button, and the controller may control the tuner to repeat the sequential locking of the plurality of channels until the confirmation signal is received, and in response to the confirmation signal, identify the currently locked channel and control the display to display an image of the identified channel on a full screen of the display.

The controller may control the display to display images of a subsequent plurality of channels in the plurality of divided regions when a number of times of locking the plurality of channels reaches a threshold predetermined number of times.

The controller may control the display to display images of a subsequent plurality of channels in the plurality of divided regions in response to the channel signal.

The display may simultaneously display a cursor with the image of the currently locked channel.

According to another aspect of an exemplary embodiment, a display apparatus includes a tuner configured to receive a broadcast signal of a plurality of channels, a display configured to display a video signal corresponding to the broadcast signal as an image, and a controller configured to divide the display into a plurality of divided regions, control the tuner to sequentially lock a plurality of channels, and control the display to display an image of a currently locked channel in one of the divided regions.

The display apparatus may further include an input including a channel button.

The controller may control the display to display the image of the currently locked channel as a moving image and an image of a previously channel as a still image in another one of the divided regions.

The controller may control the tuner to updated the currently locked channel to correspond to another channel of the plurality of channels after a predetermined time period has lapsed and control a storage to store an image of a previously locked channel.

The controller may control the display to simultaneously display the image of the currently locked channel and the stored image of the previously locked channel.

The display apparatus may further include a receiver configured to receive a channel signal of a channel button and a confirmation signal of a confirmation button, and the controller may control the tuner to repeat the sequential locking of the plurality of channels until the confirmation signal is received, and in response to the confirmation signal, identify the currently locked channel and control the display to display an image of the identified channel on a full screen of the display.

The controller may control the display to display images of a subsequent plurality of channels in the plurality of divided regions in response to the channel signal.

The controller may control the display to display images of a subsequent plurality of channels in a remaining plurality of the plurality of divided regions.

The controller may control the display to display a moving image of a reproduced content in one of the divided regions while reproducing the content and to display images of the plurality of channels in a remaining plurality of the plurality of divided regions.

The display apparatus may further include a storage configured to store a plurality of favorite channels selected by a user, and the controller may control the tuner to sequentially lock the plurality of favorite channels.

According to yet another aspect of an exemplary embodiment, a display apparatus includes a display configured to display a video signal corresponding to a currently locked channel of a plurality of broadcast signals received from an external device as an image, and a controller configured to divide the display into a plurality of divided regions and control the display to sequentially display images of a plurality of channels received from the external device in the divided regions in response to receiving an input channel signal of a channel button.

The controller may control a storage to store an image of one channel after a predetermined time period has lapsed since the one channel was locked as the currently locked channel and control the display to subsequently lock another channel as the currently locked channel and to simultaneously display an image of the another channel and the stored image of the one channel.

The controller may control the display to display the image of the currently locked channel as a moving image and the stored image as a still image.

In accordance with another aspect of an exemplary embodiment, a method of controlling a display apparatus to receive and display broadcast signals by using one tuner includes displaying an image of a channel selected by a user on a full screen of a display, determining whether a channel signal of a channel button is received, sequentially locking a plurality of channels in response to receiving the channel signal, and displaying images of the plurality of sequentially locked channels in a plurality of divided regions of the display.

The displaying of the images of the plurality of channels in the divided regions of the display may include locking a first channel, displaying an image of the first channel as a moving image for a predetermined time period, storing the image of the first channel after the predetermined time period, locking a second channel, and simultaneously displaying an image of the second channel as a moving image and the stored image of the first channel as a still image.

The method may further include repeating the sequential locking of the plurality of channels until a confirmation signal of a confirmation button is received, identifying a currently locked channel upon receiving the confirmation signal, and displaying an image of the identified channel on a full screen of the display.

The method may further include displaying images of the plurality of channels and images of another plurality of channels in the plurality of divided regions in response to again receiving the channel signal.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a perspective view illustrating a display apparatus according to an exemplary embodiment;

FIG. 2 is a control block diagram illustrating a display apparatus according to an exemplary embodiment;

FIGS. 3 to 6 are diagrams illustrating examples of channel scanning of a display apparatus according to an exemplary embodiment;

FIGS. 7A and 7B are control flowcharts illustrating a channel displaying operation on a display apparatus according to an exemplary embodiment;

FIG. 8 is a diagram illustrating an example of channel scanning corresponding to the control flowcharts of FIGS. 7A and 7B;

FIG. 9 is a control flowchart illustrating a channel displaying operation on a display apparatus according to an exemplary embodiment;

FIG. 10 is a diagram illustrating an example of channel scanning corresponding to the control flowchart of FIG. 9;

FIG. 11 is a control flowchart illustrating an operation of displaying channels according to an exemplary embodiment;

FIGS. 12 to 15 are diagrams illustrating examples of channel scanning corresponding to the control flowchart of FIG. 11;

FIGS. 16 and 17 are diagrams illustrating another example of channel scanning of a display apparatus according to an exemplary embodiment;

FIG. 18 is a control flowchart illustrating another example of channel displaying operation according to an exemplary embodiment;

FIG. 19 is a diagram illustrating an example of channel scanning corresponding to the control flowchart of FIG. 18;

FIG. 20 is a control flowchart illustrating another example of channel displaying operation according to an exemplary embodiment;

FIG. 21 is a diagram illustrating an example of channel scanning corresponding to the control flowchart of FIG. 20;

FIG. 22 is a diagram illustrating channel scanning according to an exemplary embodiment; and

FIG. 23 is a control block diagram illustrating a display apparatus according to another exemplary embodiment.

### DETAILED DESCRIPTION

Reference will now be made in detail to exemplary embodiments, examples of which are illustrated in the accompanying drawings, wherein like reference numerals refer to like elements throughout.

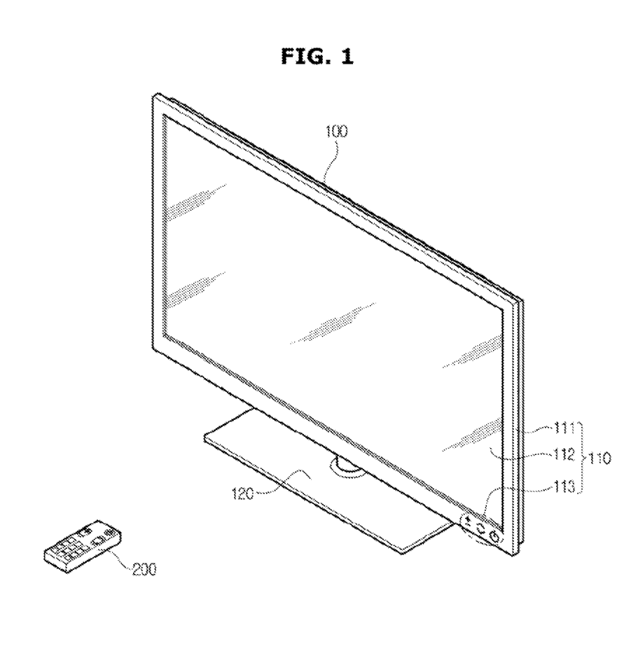

FIG. 1 is a perspective view illustrating a display apparatus 100 according to an exemplary embodiment.

The display apparatus 100 is an apparatus configured to display an image such as a television, a monitor, and a display of a mobile communication terminal, and configured to receive external broadcast signals and output the same.

The display apparatus 100 may also output a sound. In this regard, the sound may also be output via a device installed at an outer portion of the display apparatus 100.

Referring to FIG. 1, the display apparatus 100 includes a main body 110 and a stand 120 installed at a lower end portion of the main body 110 and supporting the main body 110.

The main body 110 of the display apparatus 100 may also be mounted on a wall by using a bracket.

The main body 110 of the display apparatus 100 includes a housing 111, a display 112 installed in the housing 111 and configured to display an image, and an input 113 disposed at the housing 111 and configured to receive an input operation command for operating the display 112.

In this regard, the input 113 includes a power button, channel up/down buttons, volume up/down buttons, and the like.

In addition, the display apparatus 100 may receive an operation command of a user input to a remote control 200 and perform an operation based on the received command.

The operation command of the user input to the remote control 200 include a channel change command, a channel select command, a volume change command, and the like.

That is, the remote control 200 is a device including a plurality of buttons such as a power on/off button, channel up/down buttons, volume up/down buttons, number buttons, a confirm button, direction buttons, function selection buttons, and content execution/stop buttons and configured to communicate with the display apparatus 100. The remote control 200 transmits a signal of a button manipulated by the user to the display apparatus 100.

The signal of the manipulated button corresponds to an operation command of the user.

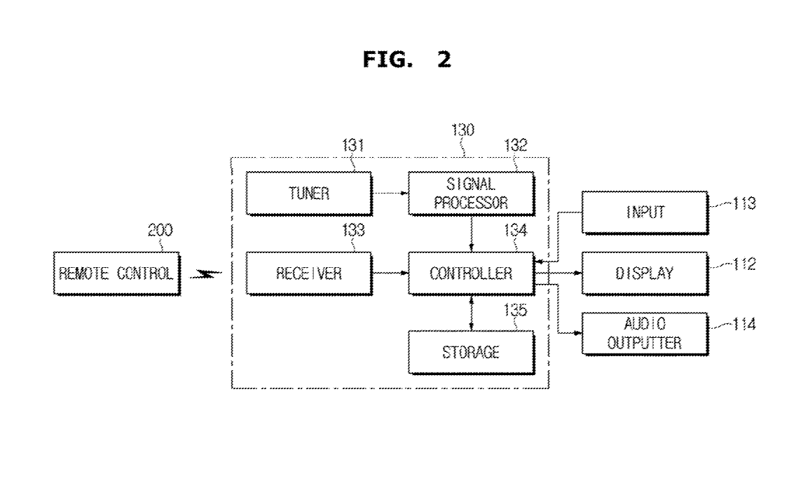

FIG. 2 is a control block diagram of a display apparatus according to an exemplary embodiment. The display apparatus may further include an audio outputter 114 configured to output a sound and a driving module 130 configured to control displaying of an image and outputting of the sound.

The display 112 displays an image based on a video signal contained in a broadcast signal.

When a channel change command is input while an image of a broadcast signal is displayed, the display 112 displays images of one or more of a plurality of channels other than the current channel.

The display 112 may also display information regarding manipulation of the remote control 200.

The display 112 may also display an image stored in a storage 135 or an image received from an external device connected to an interface.

The input 113 receives an operation command of the user and transmits a signal corresponding to the input operation command to a controller 134.

The audio outputter 114 outputs an audio signal contained in the broadcast signal as a sound.

The audio outputter 114 may also output an audio signal of a content as a sound.

The audio outputter 114 may be separated from the display apparatus 100 and installed at an outer portion of the display apparatus 100.

That is, the audio outputter 114 may be installed to communicate with the display apparatus 100 and may output a sound based on a signal received from the display apparatus 100.

The display apparatus 100 may further include an interface and may receive video and audio signals from an external device connected to the interface, and output an image and sound based on the received video and audio signals.

The driving module 130 drives the display 112 and the audio outputter 114 based on an operation command input to the remote control 200 or the input 113, and includes a tuner 131, a signal processor 132, a receiver 133, a controller 134, and a storage 135.

The tuner 131 receives broadcast signals transmitted by one of a plurality of broadcasting stations by selecting a frequency band.

That is, the tuner 131 includes one tuner and tunes broadcast signals of a desired station by using the tuner.

The signal processor 132 separates video signals and audio signals from the broadcast signals and processes the separated video signals and audio signals.

More particularly, the signal processor 132 demodulates the broadcast signals tuned by the tuner, separates video signals and audio signals from the broadcast signals, decodes the separated video signals and audio signals, converts the respective signals in accordance with signal processing standards, and outputs the resultant signals.

The broadcast signal tuned by the tuner may be digital broadcast signals or analog broadcast signals.

The driving module 130 may include a signal processor for processing digital broadcast signals, a signal processor for processing analog broadcast signals, and a switch for selecting one of the signal processors.

Also, the signal processor 132 may change characteristics of audio signals according to a user's selection, may compensate characteristics of video signals and perform signal processing thereon to output the signals.

The receiver 133 receives a button signal transmitted from the remote control 200 and transmits the received button signal to the controller 134.

The controller 134 controls outputting of an image and a sound based on a signal input to the input or received by the receiver.

The controller 134 controls operation of the tuner 131, the display 112 and the audio outputter 114 upon receiving a signal of a power on button input to the input 113, controls operation of the tuner 131 and the display 112 upon receiving a signal of a channel button input to the input 113, and controls operation of the audio outputter 114 upon receiving a signal of a volume button input to the input 113.

The controller 134 controls operation of the tuner 131, the display 112, and the audio outputter 114 upon receiving a broadcast display command input to the remote control 200 and controls execution of a content stored in a content providing server, an external device, or the storage 135 upon receiving a content reproduce command input to the remote control 200.

The controller 134 controls operation of the tuner 131 and the display 112 upon receiving a signal of a channel button input to the remote control 200 and controls operation of the audio outputter 114 upon receiving a signal of the volume button input to the remote control 200.

The controller 134 controls operation of the display 112 upon receiving the signal of the channel button from the input 113 and the remote control 200, such that a plurality of channels are sequentially locked and images thereof are displayed on one screen.

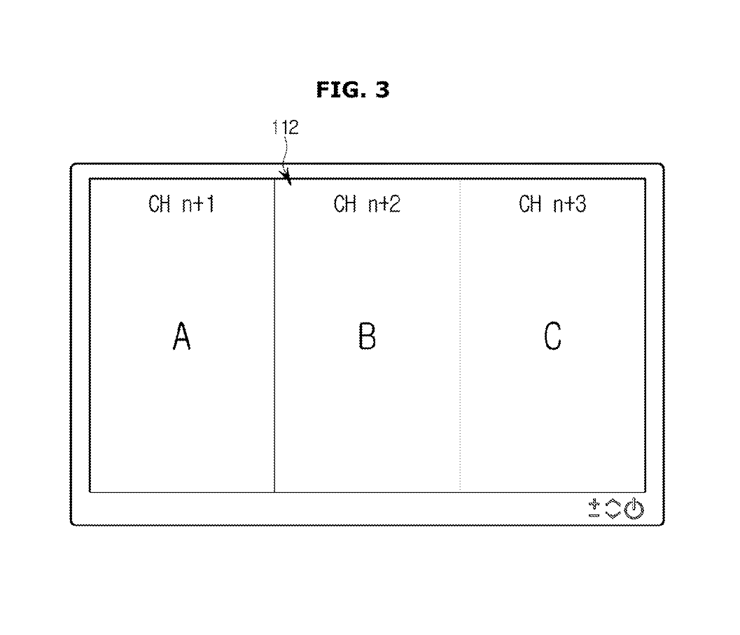

This will be described with reference to FIGS. 3 to 6.

When the signal of the channel button is input while a broadcast program of a channel N is displayed, the controller 134 determines whether the input signal of the channel button is a signal of a channel up button or a signal of a channel down button. Upon determining that the input signal is the signal of the channel up button, the controller 134 identifies a predetermined number of channels in an ascending order, and controls locking of the identified channels and displaying of images thereof.

As illustrated in FIG. 3, the display 112 identifies a channel N+1, a channel N+2, and a channel N+3, based on a command of the controller 134 and displays images of the channel N+1, the channel N+2, and the channel N+3 in divided regions of the display 112.

That is, the display 112 may display images of three channels respectively in divided regions of one screen.

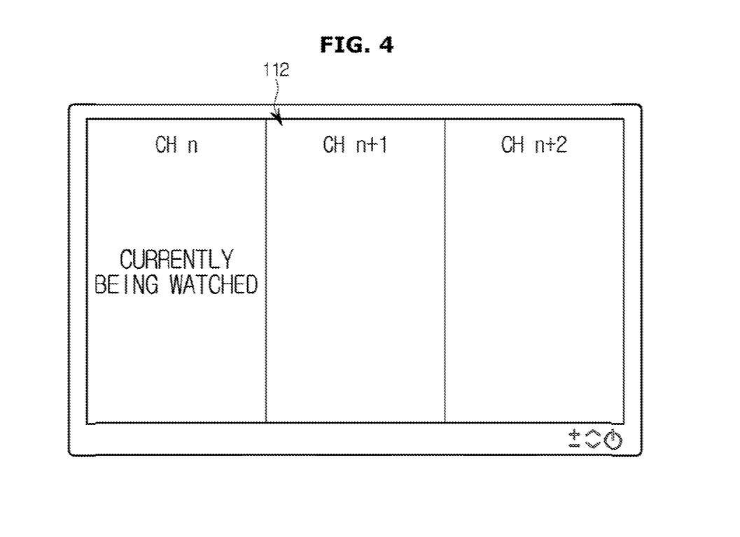

As illustrated in FIG. 4, the display 112 identifies the channel N+1 and the channel N+2, based on a command of the controller 134, and displays images of the channel N+1 and the channel N+2, as well as the image of the current channel N in divided regions of the display 112.

When the signal of the channel button is input while a broadcast program of the channel N is displayed, the controller 134 determines whether the input signal of the channel button is a signal of a channel up button or a channel down button. Upon a determination that the input signal is the signal of the channel up button, the controller 134 identifies channels higher than the channel N while determining whether favorite channels are pre-stored. Upon a determination that the favorite channels are pre-stored, the controller 134 identifies favorite channels, which are channels higher than the channel N, and controls locking of the identified channels and displaying of images thereof.

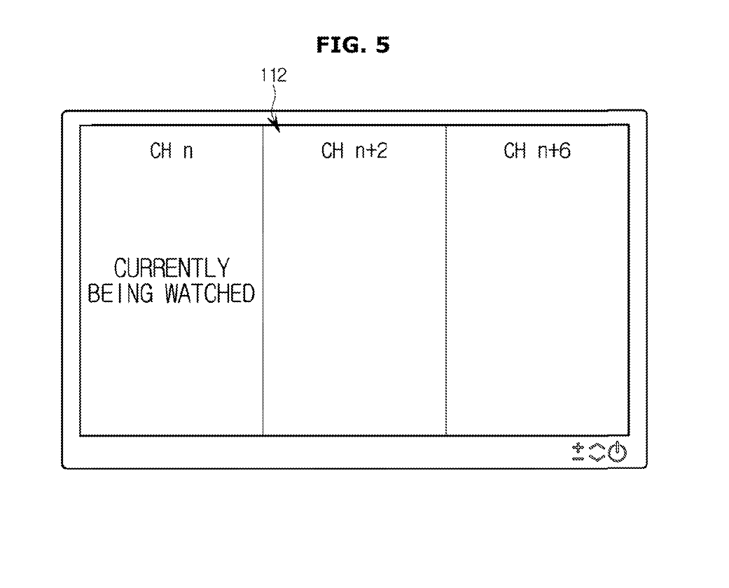

As illustrated in FIG. 5, the display 112 identifies a channel N+2 and a channel N+6, which are channels higher than the channel N and also stored as favorite channels, based on the command of the controller 134, and displays images of the channel N+2 and the channel N+6 in divided regions of the display 112, as well as the image of the channel N.

Alternatively, the display 112 may only display the identified favorite channels. That is, the image of the current channel N may not be displayed.

Also, when a signal of the channel button is input while non-broadcast content is reproduced, the controller 134 identifies a channel tuned prior to the currently reproduced content and determines whether the input signal of the channel button is a signal of a channel up button or a channel down button. Upon a determination that the input signal is the signal of the channel up button, the controller 134 identifies channels higher than the channel N, which is tuned prior to the currently reproduced content, in ascending order and controls displaying of the identified channels.

In this regard, the controller 134 may control the display 112 to divide into a first area on which an image of the reproduced non-broadcast content is displayed and a second area on which an image of the broadcast signal is displayed.

Here, the image of the content currently displayed on the entire screen of the display 112 is reduced in size and displayed in the first area when the signal of the channel button is input.

Also, when the signal of the channel button is input while the content is reproduced, the controller 134 may stop the reproducing of the content and control the display 112 to display only images of a plurality of channels.

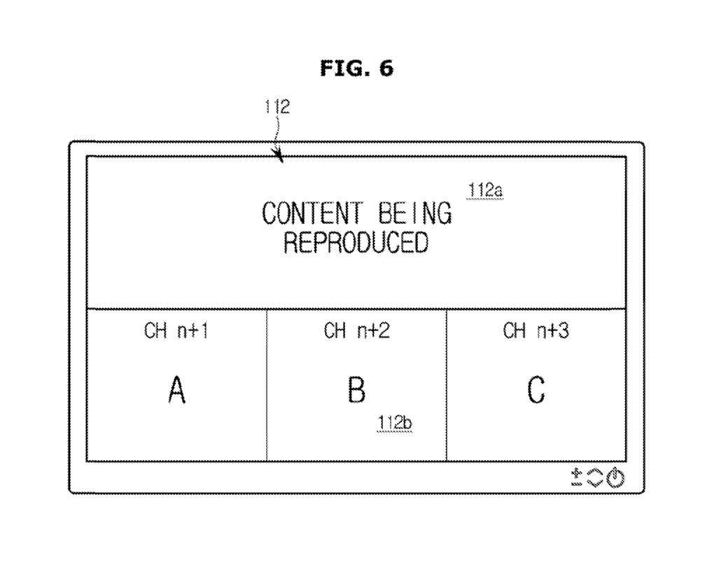

As illustrated in FIG. 6, the display 112 divides the screen into a first area 112a and a second area 112b and displays the image of the non-broadcast content in the first area 112a and images of the identified channels in the second area 112b.

The controller 134 identifies whether the received broadcast signal is a digital broadcast signal or an analog broadcast signal and performs digital broadcast signal processing or analog broadcast signal processing based on the result.

The storage 135 stores frequencies of broadcast signals by a corresponding broadcasting station.

In this regard, the frequencies of broadcast signals are frequencies used by the respective broadcasting stations for transmitting broadcast signals.

The storage 135 stores channels in numerical order.

The storage 135 stores images of unlocked channels when the images of the plurality of channels are displayed.

The storage 135 may also store favorite channels selected by the user.

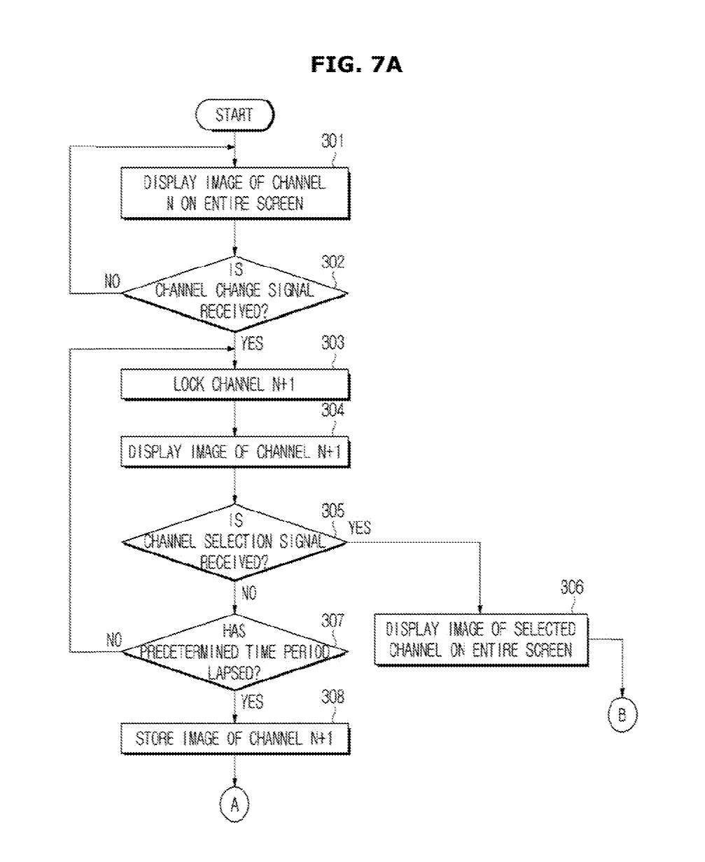

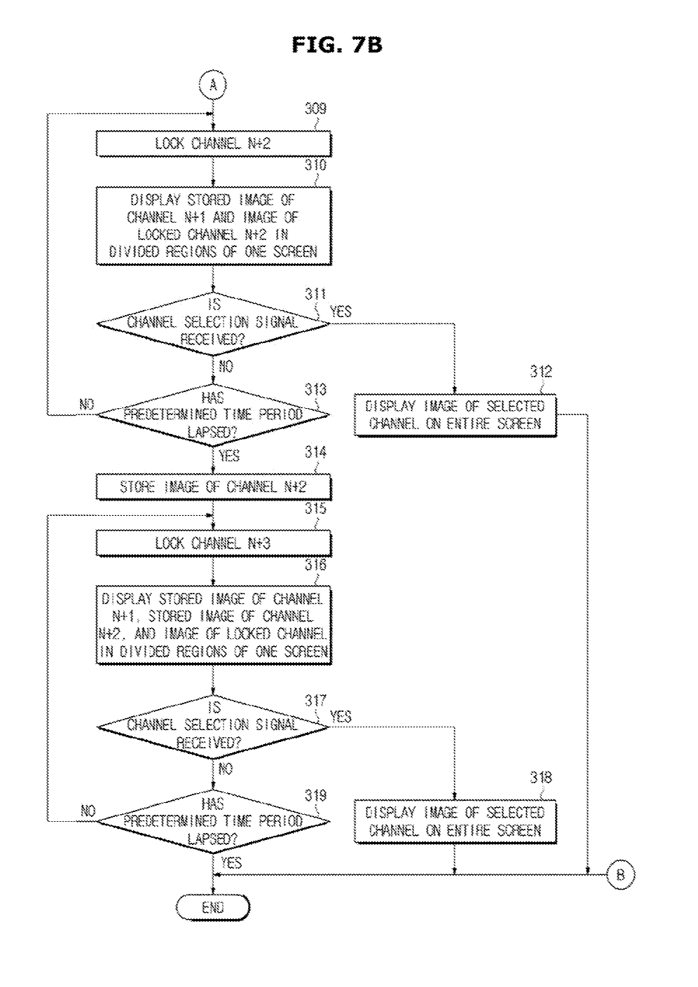

A variety of examples of displaying images of a plurality of channels on the display apparatus illustrated in FIGS. 1 and 2 will be described with reference to FIGS. 7A to 22.

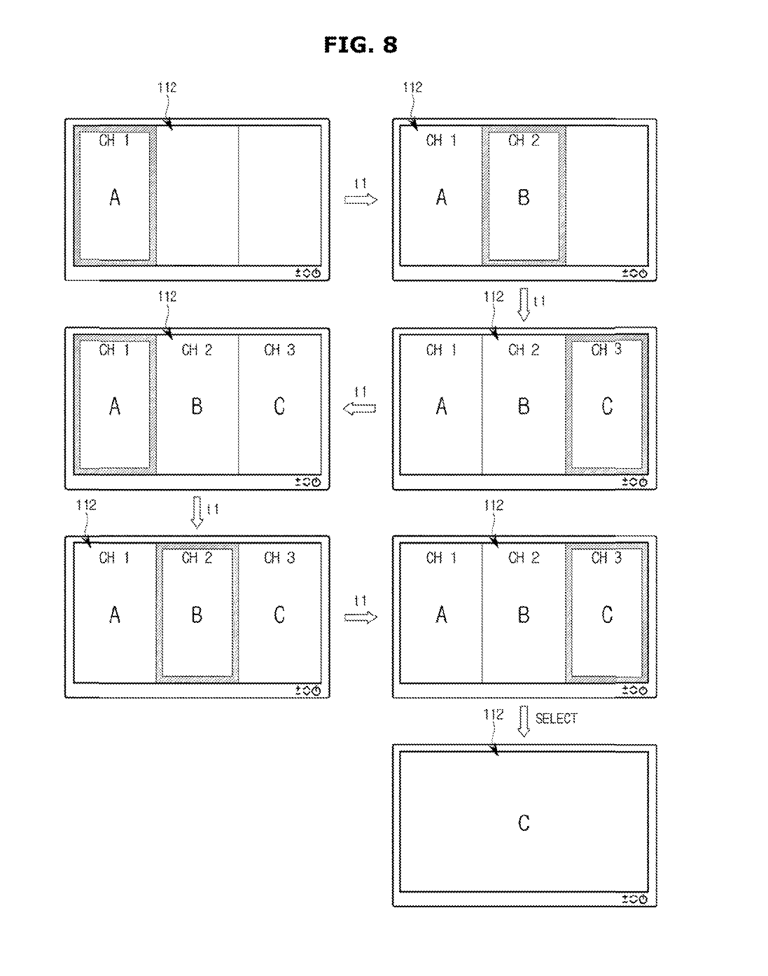

An operation of the display apparatus according to an exemplary embodiment will be described with reference to FIGS. 7A, 7B and 8.

FIGS. 7A and 7B are flowcharts illustrating a method of displaying channels on the display apparatus. FIG. 8 illustrates an example of displaying channels on the display apparatus.

When a power on signal is input, the display apparatus displays an image of a channel tuned before the power on signal is input on the entire screen of a display (301).

The display apparatus determines whether a channel change signal is input through a remote control or an input while a broadcast program of a channel N is being displayed (302). Upon a determination that the channel change signal is received, the display apparatus identifies whether the received channel change signal is a channel up signal or a channel down signal.

That is, the channel change signal is a signal of the channel button input by the user for changing channels and generated when the user presses the channel up button or the channel down button.

Hereinafter, descriptions will be given on the assumption that the channel change signal is a channel up signal and three channels are displayed.

When the channel change signal is the channel up signal, the display apparatus identifies three channels in an ascending order relative to channel N.

The display apparatus locks a channel N+1 (303) and displays an image of the locked channel N+1 on the display (304).

In this case, the display of the display apparatus divides the screen into a predetermined number of regions, displays the image of the locked channel N+1 in one of the divided regions and does not display images in the other regions.

In this regard, the image of the locked channel N+1 is a moving image.

The display apparatus determines whether a channel selection signal to select the channel N+1 is received while displaying the image of the channel N+1 (305). Upon a determination that the channel selection signal is received, the display apparatus displays the image of the selected channel N+1 on the entire screen of the display (306).

On the other hand, upon determining that the channel selection signal is not received, the display apparatus determines whether a predetermined time period t1 for displaying the image of the channel N+1 has lapsed (307). Upon a determination that the predetermined time period t1 for displaying the image of the channel N+1 has lapsed, the display apparatus stores the image of the channel N+1 (308) and locks a next channel N+2 (309).

The display apparatus displays the stored image of the channel N+1 and an image of the locked channel N+2 on the display (310).

The display apparatus divides the screen of the display into a predetermined number of regions, displays the stored image of the channel N+1 in one of the divided regions, displays the image of the locked channel N+2 in another divided region, and does not display an image in the other divided region.

Here, the stored image of the channel N+1 is a still image, and the image of the locked channel N+2 is a moving image.

The display apparatus then determines whether a channel selection signal for selecting the channel N+2 is received while displaying the images of the channel N+1 and the channel N+2 (311). Upon a determination that the channel selection signal is received, the display apparatus displays the image of the selected channel N+2 on the entire screen of the display (312).

On the other hand, upon determining that the channel selection signal is not received, the display apparatus determines whether a predetermined time period t1 for displaying the image of the channel N+2 has lapsed (313). Upon a determination that the predetermined time period t1 for displaying the image of the channel N+2 has lapsed, the display apparatus stores the image of the channel N+2 (314) and locks a next channel N+3 (315).

The display apparatus displays the stored images of the channel N+1 and channel N+2 and an image of the channel N+3 on the display (316).

In this case, the display apparatus divides the screen of the display into a predetermined number of regions, displays the stored image of the channel N+1 in one of the divided regions, displays the stored image of the channel N+2 in another divided region, and displays the image of the locked channel N+3 in the other divided region.

Here, the stored images of the channel N+1 and the channel N+2 are still images, and the image of the locked channel N+3 is a moving image.

Then, the display apparatus determines whether a channel selection signal for selecting the channel N+3 is received while displaying the image of the channel N+1, the image of the channel N+2, and the image of the channel N+3 (317). Upon a determination that the channel selection signal is received, the display apparatus displays the image of the selected channel N+3 on the entire screen of the display (318).

On the other hand, upon determining that the channel selection signal is not received, the display apparatus determines whether a predetermined time period t1 for displaying the image of the channel N+3 has lapsed (319). Upon a determination that the predetermined time period t1 for displaying the image of the channel N+3 has lapsed, the display apparatus stores the image of the channel N+3.

As described above, when the channel change signal is received, the display apparatus sequentially displays images of three channels (three is the predetermined number of channels) in ascending order and repeatedly display the images of the channel N+1, the channel N+2, and the channel N+3 once displaying of the images of the channel N+1, the channel N+2, and the channel N+3 is complete.

As illustrated in FIG. 8, the display 112 of the display apparatus displays an image A of a channel CH1 as a moving image when a channel change signal is received while an image of the channel N is displayed, displays the image A of the channel CH1 as a still image and an image B of a channel CH2 as a moving image after the predetermined time period t1, and displays the images A and B of the channels CH1 and CH2 as still images and additionally, an image C of a channel CH3 as a moving image after the predetermined time period t1.

The display 112 then sequentially selects one of the various regions to display a moving image corresponding to the channel corresponding to the region. Specifically, the display 112 of the display apparatus displays the image A of the channel CH1 as a moving image after the predetermined time period t1 has lapsed since the image C of the channel CH3 was displayed as the moving image and the images B and C as still images, displays the image A of the channel CH1 as a still image the images A and C of the channels CH1 and CH3 as still images and the image B of the channel CH2 as a moving image after the predetermined time period t1, and displays the images A and B of the channels CH1 and CH2 as still images and the image C of the channel CH3 as a moving image after the predetermined time period t1.

As described above, the display of the display apparatus displays images of three channels in the divided regions of one screen such that the stored images are displayed as still images and the image of the locked channel is displayed as a moving image.

In addition, a border of the region in which the moving image is displayed may blink in a cursor-like manner on the display apparatus.

In this regard, the user may select the image of the channel displayed as a moving image to be displayed.

According to an exemplary embodiment, the display apparatus repeats the aforementioned process until the channel change signal is input again. When the channel selection signal is received, the display apparatus recognizes the channel, the image of which is displayed as a moving image, at a time of receiving the channel selection signal as a selected channel, and displays the selected channel on the entire screen of the display. Then the display apparatus stops channel scan operation.

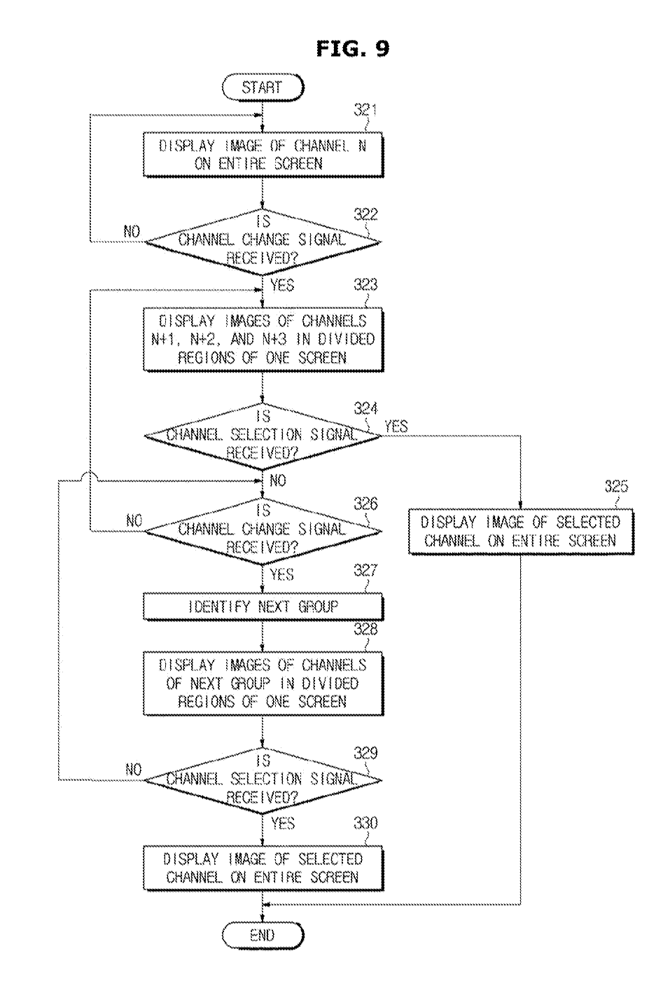

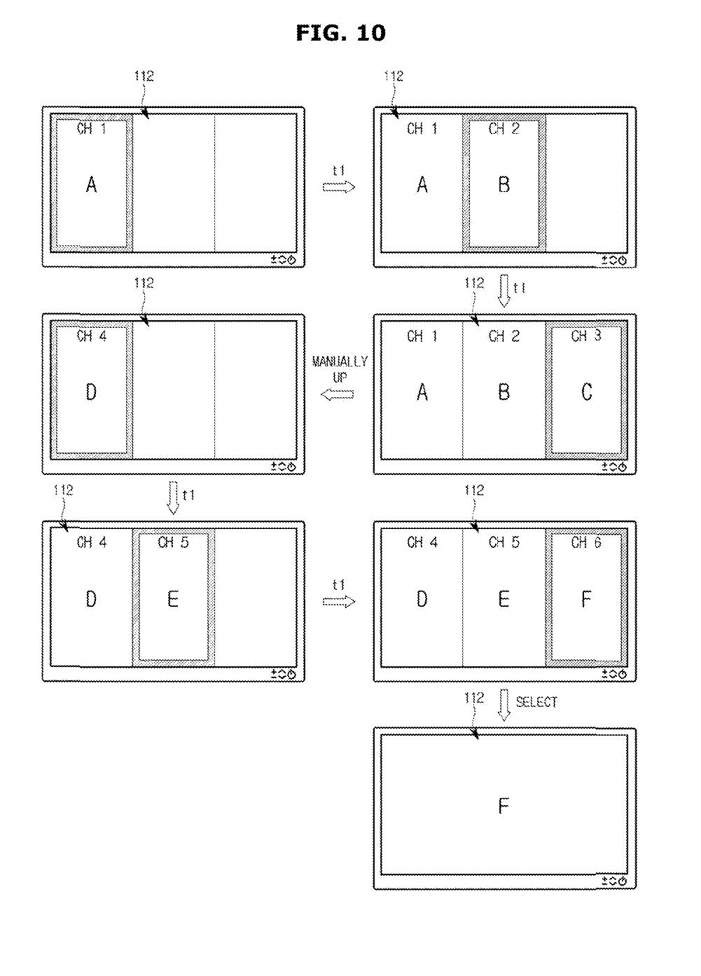

This will be described with reference to FIGS. 9 and 10.

As illustrated in FIG. 9, the display apparatus displays an image of the channel N on the entire screen of the display while a broadcast program of the channel N is being displayed (321) and determines whether a channel change signal is input through the remote control or the input while the broadcast program of the channel N is being displayed (322). Upon a determination that the channel change signal is received, the display apparatus identifies whether the received channel change signal is a channel up signal or a channel down signal.

Hereinafter, descriptions will be given on the assumption that the channel change signal is a channel up signal and three channels are displayed.

When the channel change signal is the channel up signal, the display apparatus identifies a channel higher than the channel N.

The display apparatus displays images of the channels N+1, N+2, and N+3 in divided regions of the display (323), as described above with reference to FIGS. 7A and 7B, and repeats a process of sequentially locking the channels N+1, N+2, and N+3, displaying an image of one locked channel as a moving image, and displaying images of the other channels as still images.

The display apparatus sequentially locks the channels N+1, N+2, and N+3, allows the user to recognize the locked channel by indicating the locked channel in a cursor-like manner, and determines whether a channel selection signal is received (324). Upon a determination that the channel selection signal is received, the display apparatus identifies a channel locked at the time of receiving the channel selection signal, recognizes the identified channel as a channel selected by the user, and displays the image of the selected channel on the entire screen of the display (325).

On the other hand, upon determining that the channel selection signal is not received, the display apparatus determines whether a channel change signal is received (326). The display apparatus repeats sequential locking of the channels N+1, N+2, and N+3 upon a determination that the channel change signal is not received, and identifies a next channel upon a determination that the channel change signal is received.

When the next channel of the channel N+3 is identified, a predetermined number of channels higher than the channel N+3, in ascending order, may be identified.

That is, the display apparatus identifies a plurality of channels to be displayed next as a next group (327).

The display apparatus displays images of the plurality of channels of the next group in divided regions of the display (328) by sequentially locking one of channels N+4, N+5, and N+6, displaying an image of the locked channel as a moving image, and displaying images of the other channels as still images.

The display apparatus repeats the sequential locking of the channels N+4, N+5, and N+6 and the displaying of the images thereof until a channel change signal or a channel selection signal is received.

In this case, the display apparatus updates the images stored in the storage. That is, the storage deletes the previously stored images of the channels N+1, N+2, and N+3 and stores updated images of the channels N+4, N+5, and N+6.

Upon a determination that the channel selection signal is received during the locking of the channels of N+4, N+5, and N+6 and the displaying of the images thereof (329), the display apparatus displays the image of the selected channel on the entire screen (330) and stops the channel scan operation.

Upon a determination that a channel change signal is received again, the display apparatus identifies the next group and performs the locking and displaying operation.

As illustrated in FIG. 10, the display 112 of the display apparatus displays an image A of a channel CH1, which is the channel N+1, as a moving image when a channel change signal is received while the image of the channel N is displayed, displays the image A of the channel CH1 as a still image and an image B of a channel CH2, which is the channel N+2, as a moving image after the predetermined time period t1, and displays the images A and B of the channels CH1 and CH2 as still images and an image C of a channel CH3 as a moving image after the predetermined time period t1.

Then, the display 112 of the display apparatus displays an image D of a channel CH4, which is a channel higher than the channel CH3, as a moving image when a channel change signal is received while the image of the channel CH3 is displayed as a moving image, displays the image D of the channel CH4 as a still image and an image E of a channel CH5 as a moving image after the predetermined time period t1, and displays the images D and E of the channels CH4 and CH5 as still images and an image F of a channel CH6 as a moving image after the predetermined time period t1.

Although an exemplary case in which the channel change signal is received while the image of the channel CH3 is described above, the channel change signal may also be received while the image the channel CH1 or CH2 is displayed.

In addition, a channel number may be displayed in a divided region before the image of each channel is displayed.

As described above, the display of the display apparatus may respectively display images of three channels in divided regions of one screen, such that stored images are displayed as still images, and an image of the locked channel is displayed as a moving image.

The display apparatus repeats the sequential locking of the channels N+4, N+5, and N+6 and the displaying of the images thereof until a channel change signal is input again, recognizes a channel, the image of which is displayed as a moving image at a time of receiving the channel selection signal, as a selected channel, and displays the image of the selected channel on the entire screen of the display. Then, the display apparatus stops the channel scan operation.

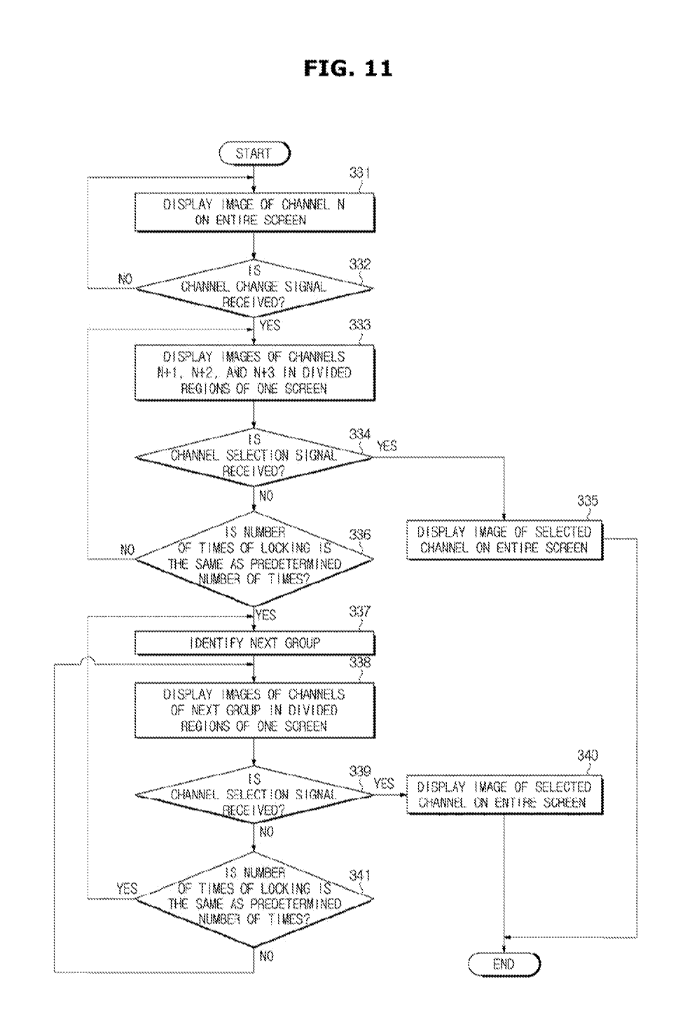

Operation of the display apparatus according to another exemplary embodiment will be described with reference to FIGS. 11 to 17.

FIG. 11 is a flowchart illustrating another example of operation of the display apparatus.

As illustrated in FIG. 11, the display apparatus displays an image of a channel N on the entire screen of the display while a broadcast program of the channel N is being displayed (331) and determines whether a channel change signal is input through the remote control or the input while the broadcast program of the channel N is being displayed (332). Upon a determination that the channel change signal is received, the display apparatus identifies whether the received channel change signal is a channel up signal or a channel down signal.

Hereinafter, descriptions will be given on the assumption that the channel change signal is a channel up signal and three channels are displayed.

When the channel change signal is the channel up signal, the display apparatus identifies a channel higher than the channel N.

The display apparatus displays images of the channels N+1, N+2, and N+3 in divided regions of the display (333), as described above with reference to FIGS. 7A and 7B, and repeats a process of sequentially locking the channels N+1, N+2, and N+3, displaying an image of one locked channel as a moving image, and displaying images of the other channels as still images.

The display apparatus sequentially locks the channels N+1, N+2, and N+3, allows the user to recognize the locked channel by indicating the locked channel in a cursor-like manner, and determines whether a channel selection signal is received (334). Upon a determination that the channel selection signal is received, the display apparatus identifies a channel locked at the time of receiving the channel selection signal, recognizes the identified channel as a channel selected by the user, and displays the image of the selected channel on the entire screen of the display (335).

On the other hand, upon determining that the channel selection signal is not received, the display apparatus determines a number of times of locking the plurality of channels of a current group displayed on the display until a predetermined number of times is reached (336). When the number of times of locking is less than the predetermined number of times, the locking of the channels N+1, N+2, and N+3 and the displaying of images thereof are repeated.

When the number of times of locking is the same as the predetermined number of times, the display apparatus automatically identifies a channel higher than the channel N+3.

That is, the display apparatus repeats the sequential locking of the channels N+1, N+2, and N+3 and the displaying of images thereof until the number of times of locking reaches the predetermined number of times.

When the channel higher than the channel N+3 is identified, the display apparatus may identify a predetermined number of channels higher than the channel N+3 in ascending order.

Here, a number of times of repeating the locking of the channels N+1, N+2, and N+3 may also be identified. That is, the display apparatus identifies a plurality of channels to be displayed next as a next group (337).

In this case, the display apparatus determines whether a last channel is contained in the plurality of channels of the next group. Upon a determination that there is the last group and the number of channels of the next group is less than a predetermined number of channels, the display apparatus may include the channel N in the next group.

Also, the display apparatus may inform the user that all channels are scanned.

Then, the display apparatus sequentially displays images of the next group of the plurality of channels in divided regions of the display (338) by repeatedly and sequentially locking channels N+4, N+5, and N+6, displaying an image of one locked channel as a moving image, and displaying images of the other channels as still images.

That is, the display apparatus repeats the sequential locking of the channels of N+4, N+5, and N+6 and the displaying of the images thereof until the channel selection signal is input or the number of times of locking reaches the predetermined number of times.

Upon a determination that the channel selection signal is received during the locking of the channels of N+4, N+5, and N+6 and the displaying of the images thereof (339), the display apparatus displays the image of the selected channel on the entire screen (341) and stops the channel up operation.

When the number of times of locking is the same as the predetermined number of times, the display apparatus identifies the next group and performs the locking of channels and displaying of images thereof.

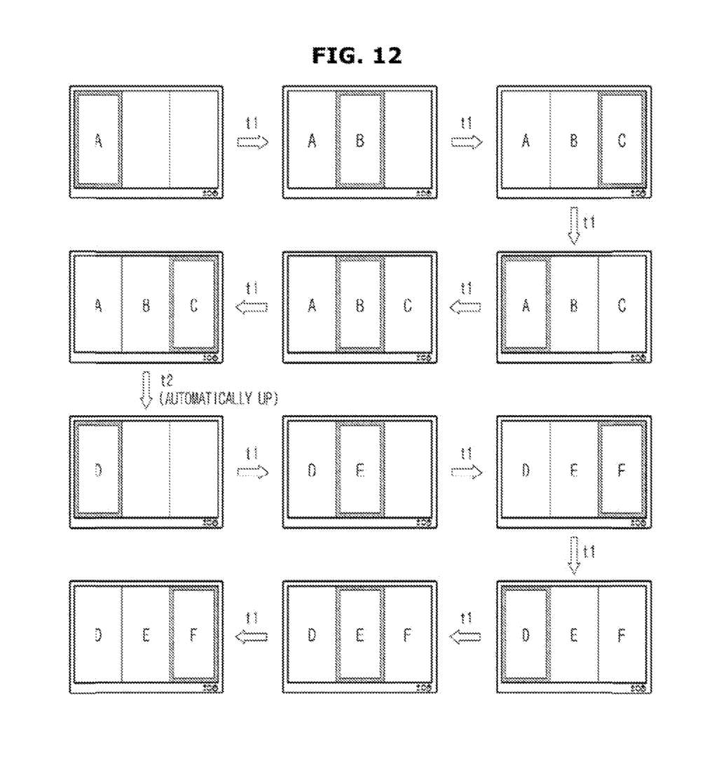

FIG. 12 is a diagram illustrating a channel scan process of the display apparatus according to an exemplary embodiment. Hereinafter, descriptions will be given on the assumption that the predetermined number of times of locking while scanning channels is six and that the predetermine number of times of repeating the locking is one.

As illustrated in FIG. 12, the display 112 of the display apparatus displays an image A of a channel CH1 as a moving image when a channel change signal is received while an image of a channel N is displayed, displays the image A of the channel CH1 as a still image and an image B of a channel CH2 as a moving image after the predetermined time period t1, and displays the images A and B of the channels CH1 and CH2 as still images and an image C of a channel CH3 as a moving image after the predetermined time period t1.

Then, upon a determination that the number of times of locking is six, the display 112 of the display apparatus displays an image D of a channel CH4 as a moving image, displays the image D of the channel CH4 as a still image and an image E of a channel CH5 as a moving image after the predetermined time period t1, and displays the images D and E of the channels CH4 and CH5 as still images, and an image F of a channel CH6 as a moving image after the predetermined time period t1.

The display apparatus repeats the sequential locking of the channels of N+4, N+5, and N+6 and the displaying of the images thereof until the number of times of locking reaches six.

As described above, the display of the display apparatus displays images of three channels in the divided regions of one screen such that the stored images are displayed as still images and the image of the locked channel is displayed as a moving image.

The display apparatus repeats the locking of the channels of N+4, N+5, and N+6 and the displaying of the images thereof until the number of times of locking reaches six, recognizes a channel, the image of which is displayed as a moving image at the time of receiving the channel selection signal, as a selected channel, and displays the image of the selected channel on the entire screen of the display.

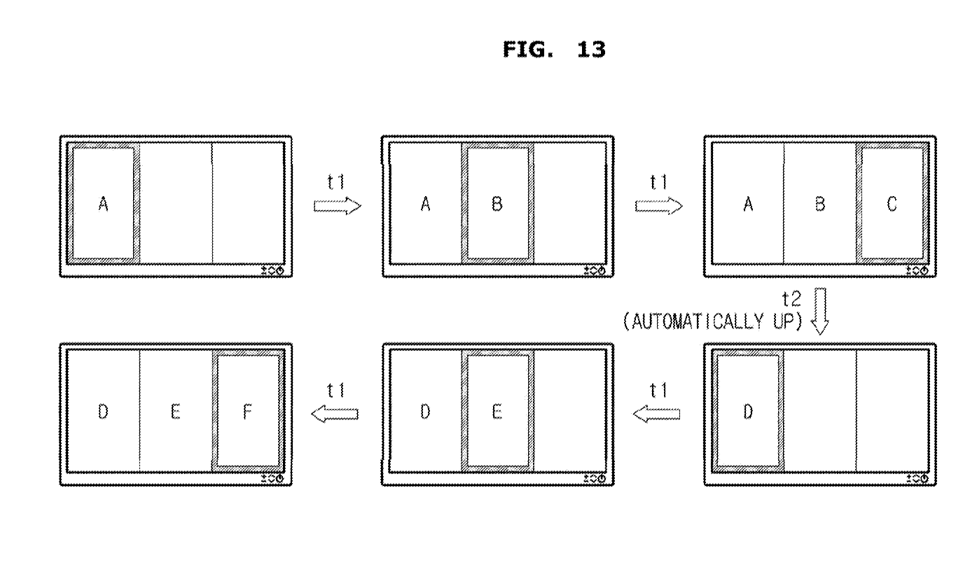

As illustrated in FIG. 13, the display apparatus may sequentially lock the channels CH1, CH2, and CH3 and display images thereof at first predetermined time intervals t1 without repeating the locking of the channels. Then, after a second predetermined time t2 has lapsed therefrom, the display apparatus sequentially locks the channels CH4, CH5, and CH6 and displays images thereof at the first predetermined time intervals t1.

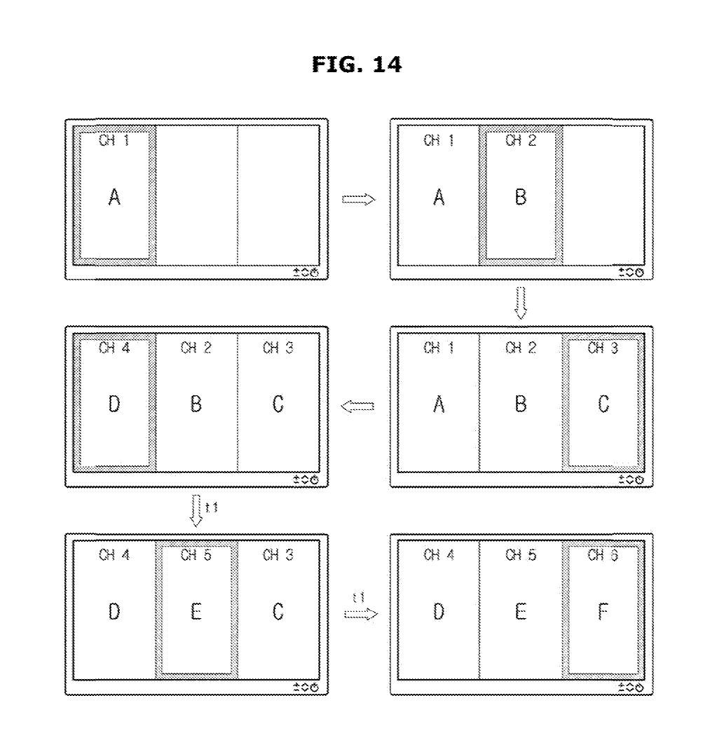

As illustrated in FIG. 14, the display apparatus may sequentially lock the channels CH1, CH2, and CH3 and display images thereof at predetermined time intervals t1 and display images of a plurality of channels of a next group such that an image of a currently locked channel is displayed in a region where an image of the first locked channel of a previous group is being displayed. In this case, the images of the other channels are maintained.

That is, when an image of the channel CH4 is displayed after the image of the channel CH3 is displayed, the display apparatus displays the image of the channel CH4 in the region where the image of the channel CH1, which is locked first among the currently displayed three channels, is being displayed and maintains the images of the other channels CH2 and CH3.

Then, the display apparatus identifies a channel higher than the channel CH4 and displays an image of an identified channel CH5 in the region where the image of the channel CH2 was displayed, which is locked first among the currently displayed three channels, and maintains the images of the other channels CH3 and CH4.

Then, the display apparatus identifies a channel higher than the channel CH5 and displays an image of an identified channel CH6 in the region where the image of the channel CH3 was displayed, which is locked first among the currently displayed three channels, and maintains the images of the other channels CH4 and CH5.

In this case, the storage of the display apparatus may store images of the previously locked channels and delete an image displayed first. That is, the storage may delete the image from the display.

Also, the storage may store images of a predetermined number of channels among the plurality of channels locked prior to the currently locked channels.

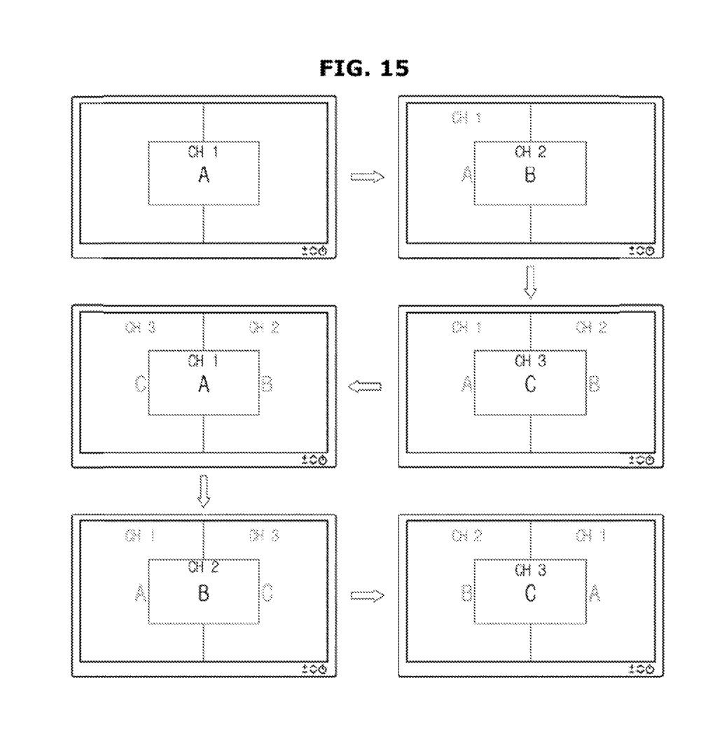

According to another exemplary embodiment illustrated in FIG. 15, when a channel change signal is received, the display apparatus may display images of a predetermined number of channels such that an image of a currently locked channel overlaps images of previously locked channels.

In this regard, the images of the previously locked channels are images stored in the storage and displayed as still images.

The display apparatus may repeatedly sequentially lock the plurality of channels of the current group and display the images thereof such that the image of the currently locked channel is emphasized to contrast with the stored images.

The display apparatus displays images of a predetermined number of channels such that the image of the currently locked channel is emphasized, a next channel is automatically locked without repeating the locking of the same channel, and an emphasized image of the locked channel is displayed on the display to be emphasized.

For example, the display apparatus displays an emphasized image of the channel CH3 among the images of the channels CH1, CH2, and CH3. After a predetermined time period has lapsed, the display apparatus automatically scans a channel CH4, higher than the channel CH3, and displays an emphasized image of the channel CH4 and the images of the channels CH2 and CH3 as a background image such that the image of the channel CH4 overlaps the images of the channels CH2 and CH3.

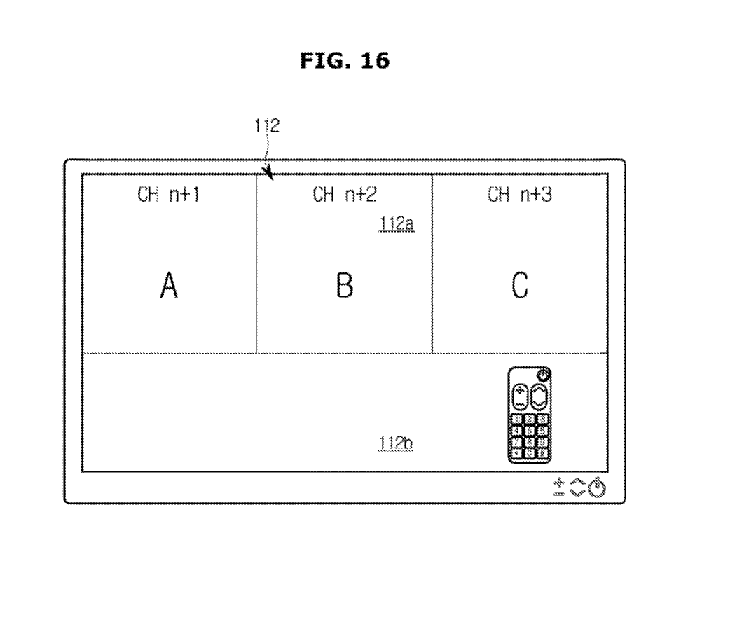

As illustrated in FIG. 16, the display apparatus divides the display 112 into two areas 112a and 112b, displays images of a plurality of channels in a first area 112a and displays a method of manipulating the remote control for selecting one of the plurality of channels in a second area 112b.

That is, the display apparatus may display an image of the remote control in the second area 112b such that buttons manipulable for selecting a channel and non-manipulable buttons are indicated using different colors.

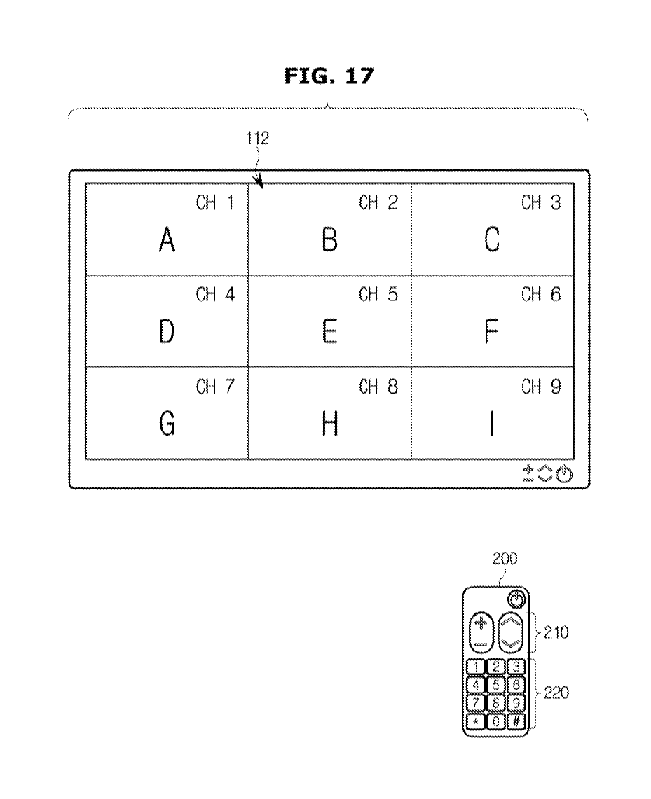

As illustrated in FIG. 17, when a channel change signal is received through a channel button 210 of the remote control, the display apparatus may display images of 9 channels in divided regions of the display based on an arrangement of number buttons 220 of the remote control.

In this case, the user may select one of the plurality of channels based on the arrangement of the number buttons 220 of the remote control.

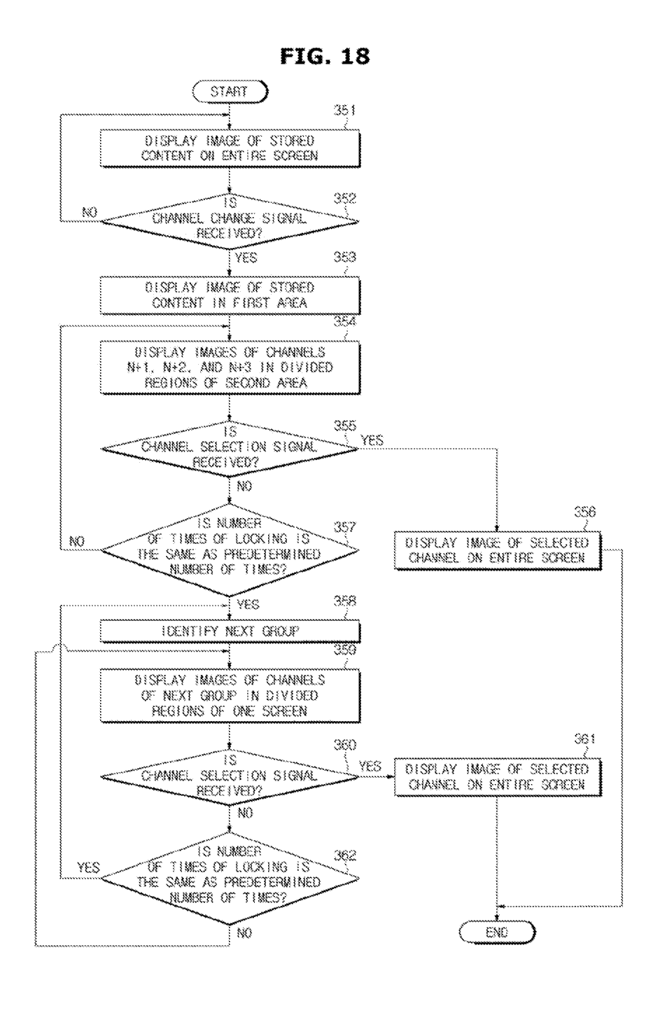

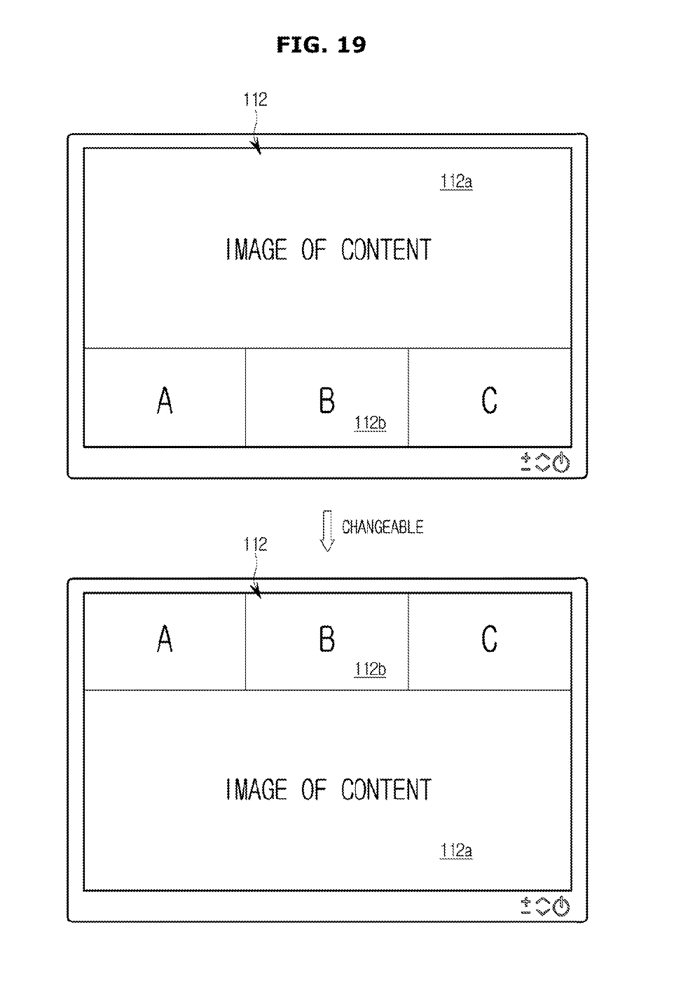

Another exemplary embodiment of operation of the display apparatus will be described with reference to FIGS. 18 and 19.

FIG. 18 is a flowchart illustrating another example of operation of the display apparatus.

As illustrated in FIG. 18, when a content stored in the storage or a content received from an external device is reproduced, the display apparatus displays an image of the content on the entire screen of the display (351).

The display apparatus determines whether a channel change signal is input through the remote control or the input while the content is reproduced (352). Upon a determination that the channel change signal is received, the display apparatus identifies a channel tuned before the content is reproduced and identifies a next channel.

Hereinafter, descriptions will be given on the assumption that the channel change signal is a channel up signal and three channels are displayed.

Then, the display apparatus divides the screen of the display into two areas, displays an image of the content being reproduced in a first area (353) and displays an image of the channel CHn tuned before the content is reproduced and images of next multiple channels CHn+1 and CHn+2 in divided regions of a second area (354), such that an image of a locked channel is displayed as a moving image and images of unlocked channels are displayed as still images.

In this regard, the displaying of the images of the plurality of channels in the divided regions of the second area of the display is similar to the operation described above with reference to FIGS. 7A and 7B.

Also, the display apparatus may display from a next channel (incremented from channel CHn) tuned before the content is reproduced. That is, the display apparatus may display images of channels CHn+1, CHn+2, and CHn+3 in divided regions of the display.

The display apparatus determines whether a channel selection signal is received while the channels CHn, CHn+1, and CHn+2 are sequentially locked and images thereof are displayed (355). Upon a determination that the channel selection signal is received, the display apparatus identifies a currently locked channel at the time of receiving the channel selection signal, recognizes the identified channel as a channel selected by the user, and displays an image of the selected channel on the entire screen of the display (356). In this case, the display apparatus stops reproduction of the content.

On the other hand, upon determining that the channel selection signal is not received, the display apparatus determines whether a number of times of locking the plurality of channels of a current group displayed on the display reaches a predetermined number of times (357). When the number of times of locking is less than the predetermined number of times, the locking of the channels N+1, N+2, and N+3, and the displaying of images thereof, are repeated.

When the number of times of locking is the same as the predetermined number of time, the display apparatus automatically identifies a next channel.

When the next channel of the channel N+2 is identified, the display apparatus may identify a predetermined number of channels higher than the channel N+2 in ascending order.

That is, the display apparatus may identify a plurality of channels to be displayed next as a next group (358).

Then, the display apparatus repeatedly displays images of the plurality of channels of the next group in divided regions of the display (359) by sequentially locking channels N+3, N+4, and N+5, displaying an image of one locked channel as a moving image, and displaying images of the other channels as still images. In this case, the display apparatus maintains the reproducing of the content in the first area of the display.

Upon a determination that the channel selection signal is received during the locking of one of the channels of N+3, N+4, and N+5 and the displaying of the images thereof (360), the display apparatus displays the image of the selected channel on the entire screen (361) and stops the channel up operation and the reproduction of the content.

When the number of times of locking is the same as the predetermined number of time (362), the display apparatus identifies a next group and performs the locking of channels and displaying of images thereof.

FIG. 19 is a diagram illustrating a channel scan process of the display apparatus. The image of the content is reduced in size and displayed in the first area 112a of the display, and the images of the plurality of channels are displayed in the second area 112b.

Also, the display apparatus may change locations of the first and second areas based on a signal received from the remote control.

When a signal of the channel button is received while reproducing content, the display apparatus may stop the reproducing of the content, remove the image of the content from the display, and display images of the plurality of channels on the display.

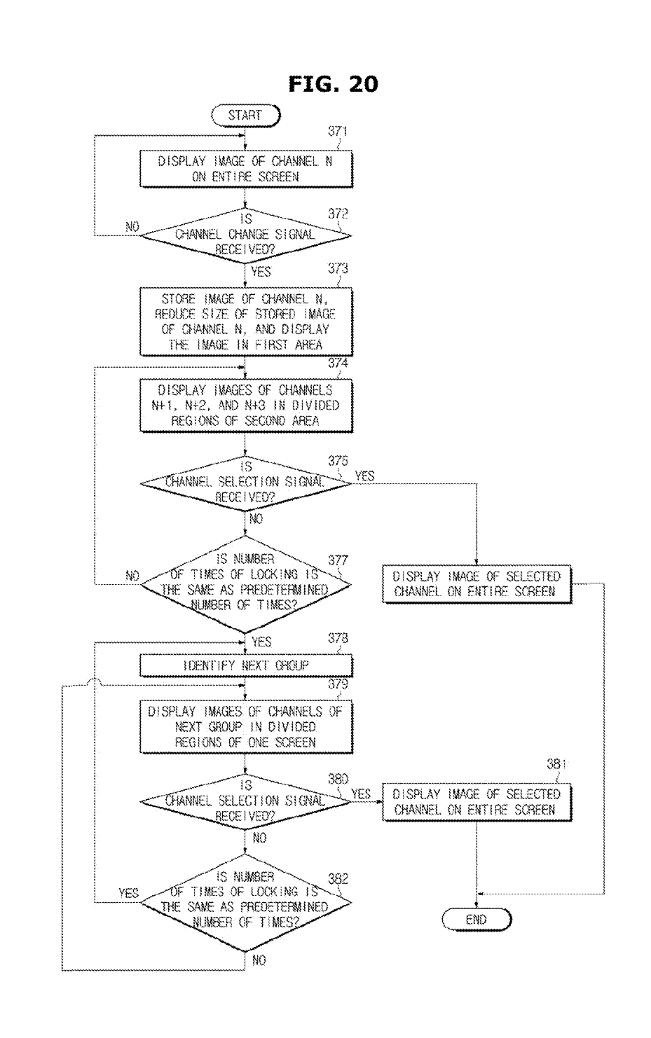

Another exemplary operation of a display apparatus according to an exemplary embodiment will be described with reference to FIGS. 20 to 22.

FIG. 20 is a flowchart illustrating another example of operation of the display apparatus.

As illustrated in FIG. 20, the display apparatus displays an image of a channel N on the entire screen of the display while a broadcast program of the channel N is being displayed (371) and determines whether a channel change signal is received through the remote control or the input while the broadcast program of the channel N is being displayed (372). Upon a determination that the channel change signal is received, the display apparatus identifies a next channel.

Hereinafter, descriptions will be given on the assumption that the channel change signal is a channel up signal and three channels are displayed.

Then, the display apparatus divides the screen of the display into two areas, displays an image of a channel currently being displayed in a first area (373) and displays images of a plurality of next channels N+1, N+2, and N+3 in divided regions of a second area of the display (374), such that an image of a locked channel is displayed as a moving image and images of unlocked channels are displayed as still images.

In this case, the display apparatus displays the image of the current channel as a still image.

In this regard, the displaying of the images of the plurality of channels in the divided regions of the second area of the display includes operation described above with reference to FIGS. 7A and 7B.

Then, the display apparatus determines whether a channel selection signal is received while the channels N+1, N+2, and N+3 are sequentially locked, and images thereof are displayed (375). Upon a determination that the channel selection signal is received, the display apparatus identifies a channel locked at the time of receiving the channel selection signal, recognizes the identified channel as a channel selected by the user, and displays the image of the selected channel on the entire screen of the display (376). Here, the display apparatus maintains displaying of the image of the current channel.

On the other hand, upon determining that the channel selection signal is not received, the display apparatus determines whether a number of times of locking the plurality of channels of a current group displayed on the display reaches a predetermined number of times (377). When the number of times of locking is less than the predetermined number of times, the locking of the channels N+1, N+2, and N+3 and the displaying of images thereof are repeated.

When the number of times of locking is the same as the predetermined number of times, the display apparatus automatically identifies a next channel.

When the next channel is identified, the display apparatus may identify a predetermined number of channels higher than the channel N+3 in an ascending order.

That is, the display apparatus may identify a plurality of channels to be displayed next as a next group (378).

Then, the display apparatus displays images of the plurality of channels of the next group in divided regions of the display (379) by repeatedly and sequentially locking channels N+4, N+5, and N+6, displaying an image of one locked channel as a moving image, and displaying images of the other channels as still images. In this case, the display apparatus maintains the displaying of the image of the current channel.

Upon a determination that the channel selection signal is received during the locking of the channels of N+3, N+4, and N+5 and the displaying of the images thereof (380), the display apparatus displays the image of the selected channel on the entire screen (381) and stops the channel up operation and the reproducing of the content.

When the number of times of locking is the same as the predetermined number of times (382), the display apparatus identifies the next group and performs the sequential locking of channels and displaying of images thereof.

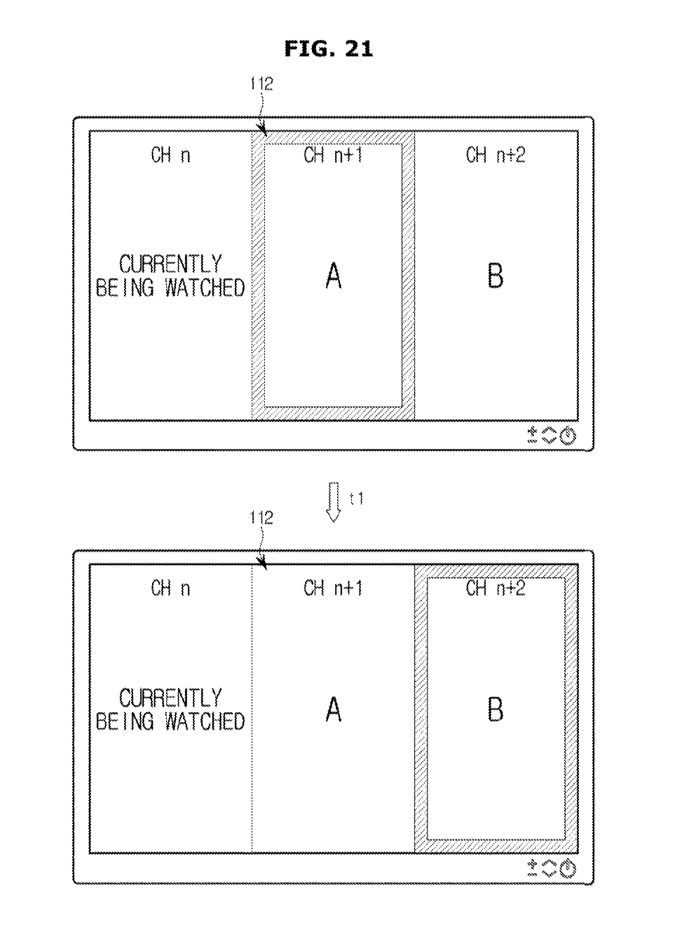

FIG. 21 is a diagram illustrating a channel scan process of the display apparatus. An image of a current channel CHn is reduced in size and displayed in a first area 112a of the display, and images of a plurality of channels CHn+1 and CHn+2 are displayed in a second area 112b.

The display apparatus repeats sequentially locking the channels CHn+1 and CHn+2, displaying an image of one locked channel as a moving image, and displaying an image of an unlocked channel as a still image. Here, the display apparatus maintains the displaying of the image of the current channel.

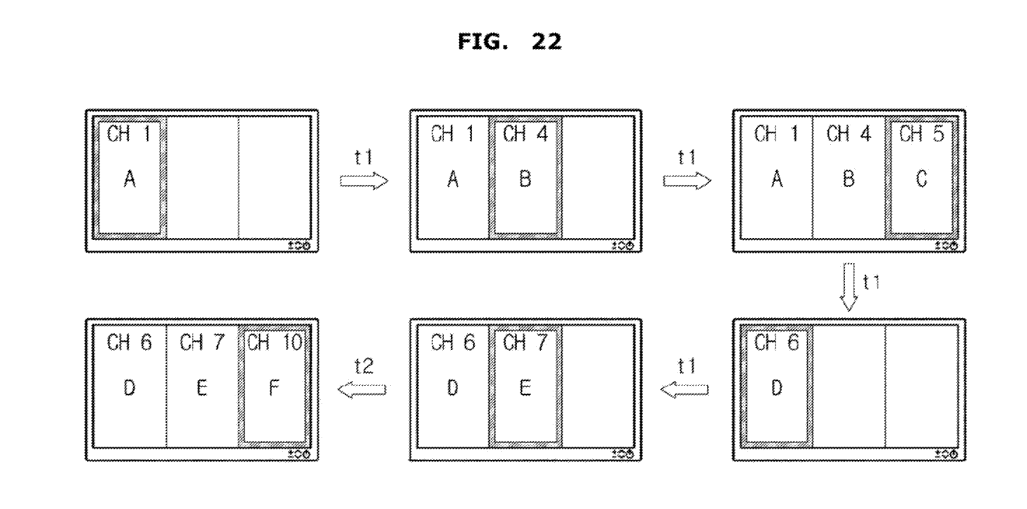

As illustrated in FIG. 22, the display apparatus may pre-store favorite channels selected by the user and may display the favorite channels in ascending order upon receiving the channel change signal.

For example, descriptions will be given on the assumption that the favorite channels selected by the user are channels 1, 4, 5, 6, 7, and 10.

When the channel change signal is received while a broadcast program of a channel N is being displayed, the display apparatus identifies favorite channels among channels higher than the channel N and displays the identified favorite channel by a predetermined number of channels.

That is, the display 112 of the display apparatus locks a channel N and displays an image A of the channel CH1 as a moving image. After a predetermined time period t1, the display 112 locks a channel CH4, displays the image A of the channel CH1 as a still image, and displays an image B of the channel CH4 as a moving image. After the predetermined time period t1, the display 112 locks a channel CH5, displays the images A and B of the channels CH1 and CH4 as still images, and displays an image C of the channel CH5 as a moving image.

Also, after the predetermined time period t1, the display 112 of the display apparatus locks a channel CH6, displays an image D of the channel CH6 as a moving image. After the predetermined time period t1, the display apparatus locks a channel CH7, displays the image of the channel CH6 as a still image, and displays an image of the channel CH7 as a moving image. After the predetermined time period t1, the display apparatus locks channel 10, displays the images D and E of the channels CH6 and CH7 as still images, and displays an image F of the channel CH10 as a moving image.

Because a plurality of channels are scanned using one tuner as described above, manufacturing costs may be reduced.

In addition, because images of a plurality of scanned channels are displayed in divided regions of one screen, the display apparatus may increase a recognition rate of the broadcast program by the user and improve user convenience.

Furthermore, because images of a plurality of channels are displayed in response to one manipulation of a channel button, the display apparatus may reduce channel scan time of the user.

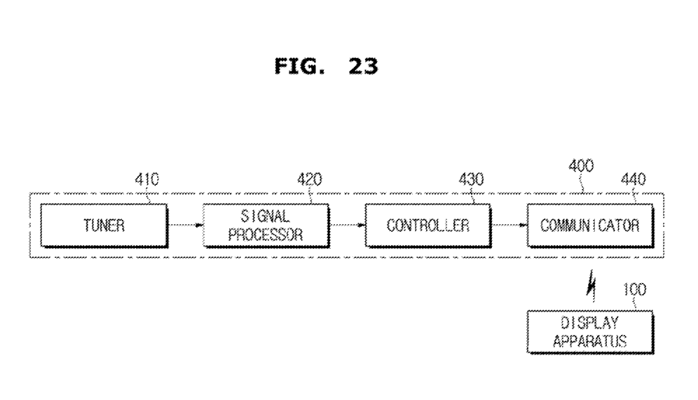

FIG. 23 is a control block diagram of a display apparatus 100 according to another exemplary embodiment.

The display apparatus 100 communicates with an external device 400 and displays an image received from the external device 400, such that images of a plurality of channels are displayed in divided regions upon receiving a signal of the channel button.

In this case, the external device 400 may be a digital video recorder (DVR) player, a set-top box, or an audio video (AV) Player and include a tuner 410, a signal processor 420, a controller 430, and a communicator 440.

The tuner 410 selects one frequency band and receives a broadcast signal transmitted by one of a plurality of broadcasting stations.

The signal processor 420 separates video signals and audio signals from the broadcast signals and processes the separated video signals and audio signals.

More particularly, the signal processor 420 demodulates the broadcast signals tuned by the tuner, separates video signals and audio signals from the broadcast signals, decodes the separated video signals and audio signals, converts the respective signals in accordance with signal processing standards, and outputs the resultant signals.

The controller 430 controls operation of the tuner 410, the signal processor 420, and the communicator 440 upon receiving a broadcast display command and controls operation of the tuner 410 upon receiving a signal of the channel button.

The controller 430 identifies a predetermined number of channels higher or lower than the current channel based on a channel up signal or a channel down signal and sequentially locks the predetermined number of identified channels, such that one channel is locked at a time and a broadcast signal of the locked channel is transmitted to the display apparatus.

The communicator 440 communicates with the display apparatus and transmits a broadcast signal received from an external device to the display apparatus upon receiving a broadcast display command from the display apparatus.

The display apparatus outputs a received broadcast signal as an image upon receiving the broadcast signal and displays images of a plurality of channels scanned by an external device upon receiving a channel change signal, such that a broadcast signal of a currently locked channel is displayed as a moving image and the image of the locked channel is stored after a predetermined time period, and subsequently, an image of a next locked channel is displayed as a moving image and images of unlocked channels are displayed as still images.

In this case, the display apparatus displays the image of the locked channel and the image of the unlocked channel in divided regions of the display.

In this regard, the image of the unlocked channel is an image stored in the storage and is displayed as a still image.

When one channel is selected while scanning the channels, the display apparatus displays the image of the selected channel on the entire screen.

Because a plurality of channels are scanned using one tuner as described above, manufacturing costs may be reduced.

In addition, because images of a plurality of scanned channels are displayed in divided regions of one screen, the display apparatus may increase a recognition rate of the broadcast program by the user and improve user convenience.

Furthermore, because images of a plurality of channels are displayed in response to one manipulation of a channel button, the display apparatus may reduce channel scan time.

Although a few exemplary embodiments of the present disclosure have been shown and described, it will be appreciated by those skilled in the art that changes may be made to these exemplary embodiments without departing from the principles and spirit of the disclosure, the scope of which is defined in the following claims and their equivalents.

What is claimed is:

1. A display apparatus comprising:
a tuner;
a display configured to display a plurality of images in a plurality of divided regions; and
a controller configured to control the tuner to sequentially lock a plurality of channels and control the display to display an image of a currently locked channel as a moving image and an image of a previously locked channel as a still image.

2. The display apparatus according to claim 1, wherein the controller is configured to control the tuner to update the currently locked channel to correspond to another channel of the plurality of channels after a predetermined time period has lapsed.

3. The display apparatus according to claim 2, further comprising a storage configured to store an image of the previously locked channel,
wherein the controller is configured to control the storage to store the image of the previously locked channel and control the display to simultaneously display the image of the previously locked channel and the image of the currently locked channel.

4. The display apparatus according to claim 1, further comprising a receiver configured to receive a channel signal of a channel button and a confirmation signal of a confirmation button,
wherein the controller is configured to control the tuner to repeat the sequential locking of the plurality of channels until the confirmation signal is received, and in response to the confirmation signal, identify the currently locked channel and control the display to display an image of the identified channel on a full screen of the display.

5. The display apparatus according to claim 4, wherein the controller is configured to control the display to display images of a subsequent plurality of channels in the plurality of divided regions when a number of times of locking the plurality of channels reaches a threshold predetermined number of times.

6. The display apparatus according to claim 4, wherein the controller is configured to control the display to display images of a subsequent plurality of channels in the plurality of divided regions in response to the channel signal.

7. The display apparatus according to claim 1, wherein the display is configured to display a cursor with the image of the currently locked channel.

8. A display apparatus comprising:
a tuner configured to receive a broadcast signal of a plurality of channels;
a display configured to display a video signal corresponding to the broadcast signal as an image; and
a controller configured to divide the display into a plurality of divided regions, control the tuner to sequentially lock a plurality of channels, and control the display to display an image of a currently locked channel in one of the divided regions.

9. The display apparatus according to claim 8, further comprising an input comprising a channel button.

10. The display apparatus according to claim 8, wherein the controller is configured to control the display to display the image of the currently locked channel as a moving image and an image of a previously locked channel as a still image in another one of the divided regions.

11. The display apparatus according to claim 8, wherein the controller is configured to control the tuner to update the currently locked channel to correspond to another channel of the plurality of channels after a predetermined time period has lapsed and control a storage to store an image of a previously locked channel.

12. The display apparatus according to claim 11, wherein the controller is configured to control the display to simultaneously display the image of the currently locked channel and the stored image of the previously locked channel.

13. The display apparatus according to claim 8, further comprising a receiver configured to receive a channel signal of a channel button and a confirmation signal of a confirmation button,
wherein the controller is configured to control the tuner to repeat the sequential locking of the plurality of channels until the confirmation signal is received, and in response to the confirmation signal, identify the currently locked channel and control the display to display an image of the identified channel on a full screen of the display.

14. The display apparatus according to claim 13, wherein the controller is configured to control the display to display images of a subsequent plurality of channels in the plurality of divided regions in response to the channel signal.

15. The display apparatus according to claim 8, wherein the controller is configured to control the display to display images of a subsequent plurality of channels in a remaining plurality of the plurality of divided regions.

16. The display apparatus according to claim 8, wherein the controller is configured to control the display to display a moving image of a reproduced content in one of the divided regions while reproducing the content and to display images of the plurality of channels in a remaining plurality of the plurality of divided regions.

17. The display apparatus according to claim 8, further comprising a storage configured to store a plurality of favorite channels selected by a user,
wherein the controller is configured to control the tuner to sequentially lock the plurality of favorite channels.

18. A display apparatus comprising:
a display configured to display a video signal corresponding to a currently locked channel of a plurality of broadcast signals received from an external device as an image; and
a controller configured to divide the display into a plurality of divided regions and control the display to sequentially display images of a plurality of channels received from the external device in the divided regions in response to receiving an input channel signal of a channel button.

19. The display apparatus according to claim 18, wherein the controller is configured to control a storage to store an image of one channel after a predetermined time period has lapsed since the one channel was locked as the currently locked channel and control the display to subsequently lock another channel as the currently locked channel and to simultaneously display an image of the another channel and the stored image of the one channel.

20. The display apparatus according to claim 19, wherein the controller is configured to control the display to display the image of the currently locked channel as a moving image and the stored image as a still image.

21. A method of controlling a display apparatus to receive and display broadcast signals by using one tuner, the method comprising:
displaying an image of a channel selected by a user on a full screen of a display;
determining whether a channel signal of a channel button is received;
sequentially locking a plurality of channels upon in response to receiving the channel signal is received; and
displaying images of the plurality of sequentially locked channels in a plurality of divided regions of the display.

22. The method according to claim 21, wherein the displaying of the images of the plurality of channels in the plurality of divided regions of the display comprises:
locking a first channel;
displaying an image of the first channel as a moving image for a predetermined time period;
storing the image of the first channel after the predetermined time period;
locking a second channel;
simultaneously displaying an image of the second channel as a moving image and the stored image of the first channel as a still image.

23. The method according to claim 22, further comprising:
repeating the sequential locking of the plurality of channels until a confirmation signal of a confirmation button is received;
identifying a currently locked channel upon receiving the confirmation signal; and
displaying an image of the identified channel on a full screen of the display.

24. The method according to claim 21, further comprising displaying images of the plurality of channels and images of another plurality of channels in the plurality of divided regions in response to again receiving the channel signal.
